(19) United States
(12) Patent Application Publication
(10) Pub. No.: US 2017/0016717 A1
(43) Pub. Date: Jan. 19, 2017

(54) DETECTION OF THE HITTING POINT

(71) Applicant: Head Technology GmbH, Kennelbach (AT)

(72) Inventor: Stefan MOHR, Dornbirn (AT)

(73) Assignee: Head Technology GmbH, Kennelbach (AT)

(21) Appl. No.: 15/123,962

(22) PCT Filed: Mar. 4, 2015
(86) PCT No.: PCT/EP2015/054547

§ 371 Date: Sep. 6, 2016

(30) Foreign Application Priority Data
Mar. 7, 2014 (DE) 10 2014 003 354.6

(51) Int. Cl. G01B 17/00; G01P 15/00

(52) U.S. Cl. CPC G01B 17/00; G01P 15/003

(57) ABSTRACT

The present invention is directed to a method for determining at least one first coordinate of the hitting point of an object on the surface of an article.

The present invention relates to a method for determining at least one coordinate of the hitting point of an object on the surface of an object.

It may be of utmost interest in many different technical fields to determine the hitting point or point of contact of a moving object on the surface of a static or likewise moving article or body as precisely as possible. An airplane, for example, may collide with an object, such as, for example, a bird or a swirled-up piece of waste or the like during take-off or landing. In such a case, the surface of the airplane or at least of the wings usually must be thoroughly searched for potential damage. To this end, it would be helpful to be able to automatically determine the hitting point of the object as precisely as possible so that only a small area has to be searched by hand. Similar problems arise in the case of collisions of birds with the wings of windmills, of space debris with satellite panels, of icebergs or floating refuse with ship hulls, of stones (stone-chipping) with passenger cars, trucks or bicycles and in other comparable situations.

This problem likewise arises in the area of ball game sports, even though for other reasons: It has been known for a long time that the hitting point of a ball on the string bed of a ball game racket has a very decisive influence on the player's performance and efficiency. If the so-called “sweet spot” of the racket is hit, both the transmission of power from the racket or its string bed to the ball and the control of the flight direction of the ball are optimal. Therefore, it has been attempted already some time ago to provide tennis rackets by means of which it can be determined or checked whether the ball hit this sweet spot. DE 198 16 389 A1, for example, describes a tennis racket which is meant for practicing the hitting accuracy and for improving the stroke efficiency and in whose string bed a sensor is integrated. This sensor outputs a signal if, and only if, it is hit by the ball. If the ball hits beside the sensor, no signal is generated. DE 29 425 33 A1 also describes a tennis racket comprising a hitting signal transmitter by which a hitting signal is generated if the tennis ball hits on a central area of the string bed. However, these tennis rackets are disadvantageous in that the player is only given a qualitative signal (sweet spot hit or sweet spot not hit) without, however, getting any information about the actual hitting point of the ball on the string bed. U.S. Pat. Nos. 4,101,132 and 4,257,594 provide an improved tennis racket in as far as a plurality of areas can be defined in it and a plurality of sensors permit to determine which of these areas was hit by the ball. However, this kind of tennis rackets, too, only generates a discrete signal. Moreover, this tennis racket becomes technically complex with an increasing number of areas due to the great number of sensors necessary and therefore it becomes correspondingly expensive. Finally, EP 0 377 614 B1 describes a tennis racket including a multiple number of sensing means located at the periphery of the string bed for detecting shock waves caused when the ball hits the strings and propagating along the strings. Subsequently, respective moments at which the shock wave vibrations are initially detected by the respective sensing means are differentiated. If the respective moments thus detected fall within a reference time frame corresponding to the sweet spot, a signal is provided that the tennis racket has been hit within the sweet spot. However, as will be readily understood, such a tennis racket requires an extremely high time resolution if the hitting point of the ball is to be determined accurately to the centimeter. Accordingly, the necessary sensors are technically highly sophisticated and thus expensive.

On the basis of the specific solutions known from the prior art for ball game sports, the problem underlying the present invention resides in providing quite generally an improved method for determining at least one coordinate of the hitting point of an object on the surface of an article or body, said method taking into account the above discussed disadvantages of the methods known from the prior art. This problem is solved by a method according to claims 1 and 2. Preferred embodiments of the present invention are described in the dependent claims.

The present invention is directed, i.a., to a method for determining at least one first coordinate of the hitting point or point of impact of a preferably moveable object on the surface of a static or likewise moving article or body. The article or body may be generally any article or body whatsoever. Preferably, the article is an extended or elongate article.

Preferred examples for such articles or bodies are: airplanes, airplane wings, helicopter wings, wings of windmills, satellites, ship hulls, ship propellers, passenger cars, trucks, bicycles, telescopes, solar cells, ball game rackets, etc. The object may be generally any object whatsoever. Preferably, the object is relatively small in comparison to the article or body. Preferably the maximum extension of the object is at most 15%, most preferably at most 10% of the maximum extension of the article or body. Preferred examples of such objects are: birds, insects, bugs, floating refuse, such as, e.g., driftwood, icebergs, stones, hailstones, balls, space debris particles, etc.

The longitudinal axis of the article defines an x-coordinate, the transverse axis along the width of the article defines a y-coordinate and the perpendicular to the x-coordinate and the y-coordinate along the height of the article defines a z-coordinate. According to the invention, at least one first kinematic variable along a first direction is measured at a first point of the article as a function of time, wherein the sampling rate is preferably at least 50 Hz. The at least first measured kinematic variable is then transformed into the frequency space. At least the first coordinate of the hitting point of the object on the surface of the article is determined on the basis of the transformed kinematic variable in the frequency space.

Furthermore, the present invention relates to a method for determining a first and a second coordinate of the hitting point or point of impact of an object on the surface of such an article. According to this alternative preferred embodiment of the present invention, a first kinematic variable along a first direction is measured at a first point of the article as a function of time and a second kinematic variable along a second direction is measured at a second point of the article as a function of time. The sampling rate at the measurement of the first and/or the second kinematic variable is preferably at least 50 Hz. The measured first kinematic variable and the measured second kinematic variable are transformed into the frequency space. Alternatively or additionally, it is also possible to transform a linear combination of the measured first kinematic variable and the measured second kinematic variable into the frequency space. On the basis of the transformed kinematic variable(s) in the frequency space, the first and/or the second coordinate of the hitting point is determined.

The transformation into the frequency space can be performed by means of known techniques, such as, for example, DFT, preferably FFT. The kinematic variable may be the speed, the acceleration or another kinematic variable. The measurement is preferably made with an acceleration sensor and/or a gyrometer. Instead of the actually measured kinematic variable, it is also possible to transform a variable derived therefrom. It is possible, for example, to measure the speed, to derive the acceleration therefrom and then to transform the acceleration into the frequency space and vice versa. The first and second coordinates of the hitting point denote coordinates within the plane of the surface of the article or body. The first and second coordinates are preferably perpendicular to each other. The first and second coordinates are most preferably aligned with the x- and the y-coordinates, respectively.

Preferably, the first direction is substantially identical to the second direction. Most preferably, the first and second directions are substantially parallel to the z-coordinate. In other words, the speed or acceleration is preferably measured perpendicular to the length and width of the article. The article is preferably an approximately plane article, such as, for example, a wing of an airplane or a of windmill. The first and second directions are then preferably aligned perpendicular to this surface area.

The first point of the article may be identical to the second point of the article. Thus, the first kinematic variable and the second kinematic variable, for example, can be measured with one and the same sensor. However, the first point preferably differs from the second point. Most preferably, at least one of the two points is outwardly offset with respect to the longitudinal axis of the article.

Preferably, the determination of the first and/or the second coordinate of the hitting point on the basis of the transformed kinematic variable(s) in the frequency space comprises the following steps: determining a characteristic frequency interval, determining at least one characteristic value of the first and/or the second kinematic variable with respect to the characteristic frequency interval, and determining the first and/or the second coordinate of the hitting point on the basis of the at least one characteristic value. The characteristic frequency interval is preferably determined or defined in advance and depends, i.a., on the vibration properties of the article or body and the kind and size of the hitting object. The lower limit of the characteristic frequency interval is preferably between 0 Hz and 100 Hz, more preferably between 5 Hz and 80 Hz and most preferably between 10 Hz and 50 Hz. The upper limit of the characteristic frequency interval is preferably between 20 Hz and 500 Hz, more preferably between 25 Hz and 400 Hz and most preferably between 30 Hz and 300 Hz. According to this preferred embodiment of the method according to the invention, the determination of the hitting point is made on the basis of relatively low frequencies. Accordingly, no temporally high-resolution measurements of the kinematic variables are required for the method according to the invention. Thus, it is possible to use relatively simple standard sensors, which are correspondingly inexpensive.

The characteristic value preferably can be one or a combination of the following values: local or absolute minimum of the first and/or the second kinematic variable in the characteristic frequency interval, local or absolute maximum of the first and/or the second kinematic variable in the characteristic frequency interval, mean value of the first and/or the second kinematic variable in the characteristic frequency interval, mean value of the first and/or the second kinematic variable in a partial interval of the characteristic frequency interval. It has turned out according to the invention that the hitting point of the object on the surface of the article leaves a characteristic signature in the frequency space of the respective kinematic variable. Since this signature may have different effects, the present invention is not limited to specific characteristic values. In fact, different characteristic values directly correlated with the hitting point of the object can be defined depending on the arrangement of the sensors and the vibration properties of the article. The present invention, i.a., is essentially based on the basic idea that the frequency spectrum correlates with the hitting point of the object on the surface of the article in different but specific ways. This correlation can be found for any article by corresponding experiments. Once such a correlation is known, the first and/or the second coordinate of the hitting point can be identified by analyzing the spectrum in the frequency space and determining a specific characteristic value of the kinematic variable in the frequency space. This can be made, for example, by means of a table that correlates each of specific characteristic values with a specific hitting point of the object. Preferably, however, the first and/or the second coordinate is a function of one or more characteristic values.

According to a preferred embodiment, the first coordinate is the x-coordinate, the first direction is substantially parallel to the z-coordinate and the first point is provided near or at a long-side end of the article. According to a further preferred embodiment, the first coordinate is the x-coordinate, the second coordinate is the y-coordinate and the first and the second direction are substantially parallel to the z-coordinate. In this further preferred embodiment, the first point is provided near or at a long-side end of the article and the second point is provided near or at an opposite long-side end of the article.

The present invention further relates to an article comprising at least one first sensor for measuring at least one first kinematic variable and a central processing unit, wherein the first sensor and the central processing unit are adapted to carry out the method as described above. Preferably, the article further comprises a second sensor for measuring at least one second kinematic variable. The present invention further relates to an article comprising an acceleration sensor and a central processing unit adapted to determine a coordinate of the hitting point of an object onto the surface of an article from the acceleration in a first direction measured by the acceleration sensor. Preferably, the article further comprises a second acceleration sensor, wherein the central processing unit is adapted to determine two coordinates of the hitting point of an object onto the surface of an article from the accelerations in the respective directions measured by the two acceleration sensors.

Preferably, the central processing unit is adapted to determine two coordinates of the hitting point of an object onto the surface of the article from the acceleration in a first direction measured by the acceleration sensor. Preferably, the article further comprises a gyrometer, wherein the central processing unit is adapted to determine a second coordinate of the hitting point of an object onto the surface of the article from the acceleration measured by the gyrometer.

In the following, preferred embodiments of the present invention are described in more detail with reference to the Figures, in which

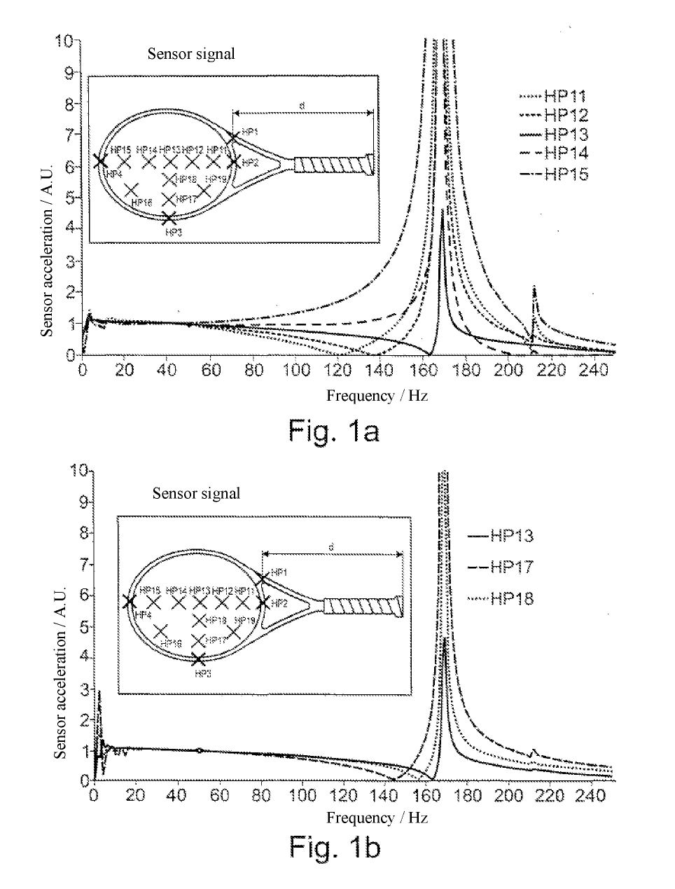

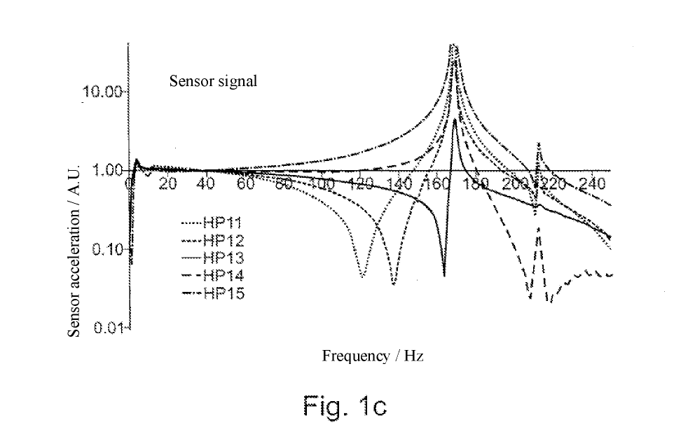

FIGS. 1a-c show the measuring result of an experiment;

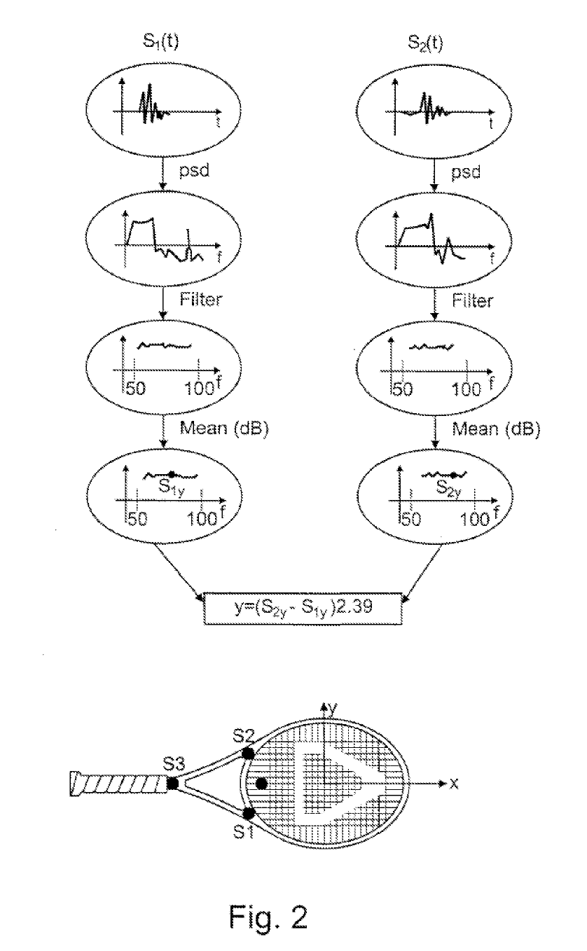

FIG. 2 shows a flow chart for an exemplary algorithm for the determination of the y-coordinate; and

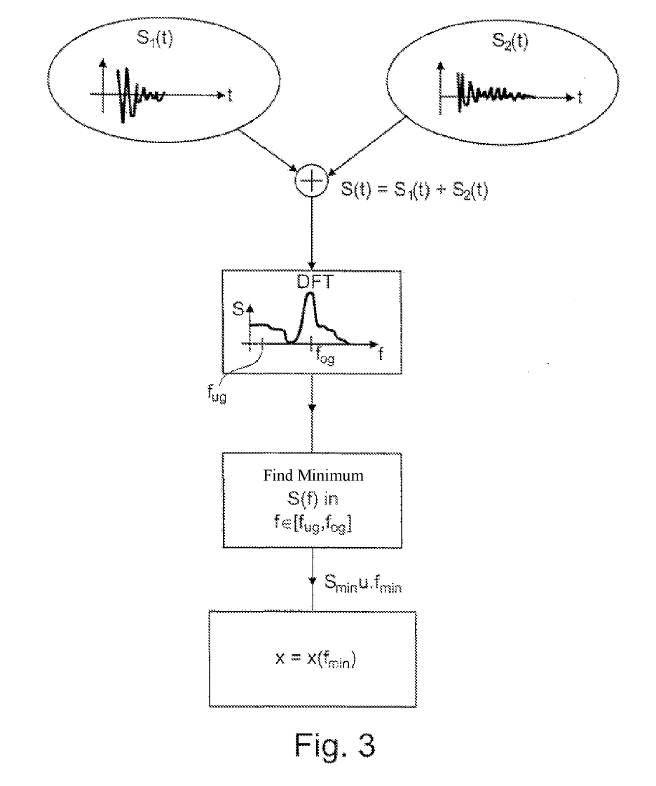

FIG. 3 shows a flow chart for an exemplary algorithm for the determination of the x-coordinate.

FIGS. 1a to 1c illustrate the result of an experiment by means of which it is meant to exemplarily explain the basic idea on which the present invention is based. Even if the following description refers to the example of a tennis racket, the method explained by means of this example basically can be applied to any objects and articles whatsoever.

The diagrams respectively shown in FIGS. 1a and 1b schematically illustrate a tennis racket (in the experiment discussed here, the “Extreme MP” model of Head was used) at the racket head of which two sensors are attached whose positions are schematically indicated by respective crosses and the designations HP1 and HP2. The sensors are acceleration sensors of the type “Bruel & Kjoer 4501”. The string bed of the tennis racket was hit by means of a hammer at defined points, wherein the power of impact is irrelevant since it can be “scaled out”. The hitting points of the hammer HP11 to HP19 are denoted by crosses in each of the diagrams shown in FIGS. 1a and 1b. The respective acceleration was measured by the sensors at the positions HP1 and HP2 during the hitting moment and subsequently thereto. In FIGS. 1a, the Fourier-transformed signal of the sensor at the position HP1 is illustrated as a function of frequency for the hitting points HP11 to HP15. The corresponding signal for the hitting points HP13, HP 17 and HP18 is illustrated in FIG. 1b. As can be clearly seen, the different curves clearly differ in their shapes from each other depending on the respective hitting point. The curves exhibit, for example, respective minima that occur at clearly different frequencies depending on the respective hitting points. In the case of logarithmic scaling as depicted for the curves of FIG. 1a in FIG. 1c, these minima are even more clearly pronounced and it can be clearly seen how the minima are shifted towards the greater frequencies with increasing distance d of the hitting points from the racket handle.

The idea of the present invention is based on generating a correlation between the specific curve shape in the frequency space and the actual hitting point of the ball (i.e., the object) on the string bed (i.e., the surface of the article). Once such a correlation has been established empirically, the hitting point of the ball can be determined in a simple way by measuring the acceleration and transforming the measuring signal into the frequency space. This approach can analogously be applied, for example, to the situation of a bird hitting on the wing of an airplane. If the typical hitting speed and the typical weight of such a bird are known, a correlation between the specific curve shape of the measuring signal in the frequency space and the actual hitting point of the bird on the wing can be determined empirically.

As apparent from the example of FIG. 1, it is generally possible for this purpose to define different characteristic values on the basis of which the correlation can be made. The curves in FIG. 1, for example, differ not only in the positions of their minima but also, for example, in differently pronounced maxima or in different amplitudes at, for example, 120 Hz. Therefore, it is emphasized that the exemplary embodiments of specific algorithms for the determination of the x-coordinate and/or the y-coordinate of the hitting point as described in more detail in the following are only preferred embodiments which, however, are not to be understood as being limiting. In fact, other characteristics of the different curves in the frequency space can be determined by means of which conclusions with respect to the position of the hitting point can be drawn.

FIGS. 2 and 3 illustrate a specific embodiment of a method for determining an x-coordinate as well as a y-coordinate according to the invention. The diagram shown in FIG. 2 schematically illustrates an article with a definition of the x-coordinate and the y-coordinate, wherein the origin of the coordinate system is formed by the centroid of the string bed. One acceleration sensor each can be arranged at one or more of the positions S₁, S₂ and S₃. The acceleration sensor S₃, however, is not necessary for the embodiment discussed here. The only acceleration sensors required are the two acceleration sensors S₁ and S₂, which are preferably attached at the two arms or rather are respectively arranged at the transition of each of the arms into the bridge. Preferably, the acceleration sensors S₁ and S₂ measure the acceleration along the z-direction, i.e. perpendicular to the x-coordinate and the y-coordinate, over a period of preferably 2 s at a sampling rate of preferably 10,000 s⁻¹.

Each of FIGS. 2 and 3 schematically depicts the measuring signals of the acceleration as functions of time of the two sensors S₁ and S₂ as S₁(t) and S₂(t), respectively. FIG. 2 depicts a preferred flow chart for determining the y-coordinate, while FIG. 3 depicts a preferred flow chart for determining the x-coordinate.

In the case of the determination of the y-coordinate as exemplarily illustrated in FIG. 2, firstly the power spectral density (psd) of the measured signals S₁(t) and S₂(t) is determined. In other words, the measured kinematic variable is transformed into the frequency space. To this end, for example, a discrete Fourier transformation, such as, e.g., FFT (fast Fourier transformation) may be used. Each of the transformed signals is subsequently filtered. The filtering step can be performed by means of known techniques, such as, for example, a digital bandpass filter (e.g. the third order Butterworth filter). Subsequently, a characteristic value of the transformed signal is determined on the basis of a characteristic frequency interval. In the illustrated embodiment, the characteristic frequency interval is [50 Hz, 100 Hz] and the characteristic value is the mean value of the transformed function in this frequency interval. In the case of, for example, a wing of an airplane instead of a tennis racket, the characteristic frequency interval may be at considerably lower frequencies and for example be [0 Hz, 20 Hz] or [5 Hz, 25 Hz]. If the mean values of the sensors S₁ and S₂ thus determined are denoted by S_{1y} and S_{2y}, respectively, the y-coordinate of the hitting point can be determined by means of the following formula, wherein the values of S_{1y} and S_{2y} are to be indicated in the unit m/s² and the result provides the y-coordinate in cm:

y=(S_{2y}−S_{1y})2.39

This formula was heuristically determined for a specific tennis racket. In the case of another type of racket and in particular in the case of another article or body, such as, for example, a wing of an airplane, the individual numerical values of the above formula may considerably deviate from the embodiment discussed here. Furthermore, as already mentioned, it may be advantageous in the case of another article to determine another characteristic frequency interval and/or another characteristic value.

FIG. 3 depicts the corresponding algorithm for the exemplary determination of the x-coordinate in a flow chart. In the present embodiment, firstly the two measuring signals S₁(t) and S₂(t) of the sensors S₁ and S₂ are added and the thus obtained signal S(t) is converted into a power spectral density S(f) by means of, for example, a discrete Fourier transformation (DFT). Subsequently, an upper limit frequency f_{og} as well as a lower limit frequency f_{ug} of the characteristic frequency interval [f_{ug}, f_{og}] is determined. Preferably, the interval is [10 Hz, 200 Hz]. The minimum of S(f) and the respective frequency fₘᵢₙ are then determined on the basis of this characteristic frequency interval. The x-coordinate is then a function of the respective minimum frequency fₘᵢₙ:x=x(fₘᵢₙ). In a preferred embodiment, the x-coordinate of the hitting point can be determined by means of the following formula, wherein the frequency values are to be indicated in the unit Hz and the result provides the x-coordinate in cm:

x=(fₘᵢₙ−150)/5.7, if fₘᵢₙ<170

x=(fₘᵢₙ−210)/10, if fₘᵢₙ<170

Alternatively, the x-coordinate can also be a function of the minimum frequency as well as the two frequencies of the characteristic frequency interval:

x=x(fₘᵢₙ, f_{ug}, f_{og})

As has been explained several times, these two exemplary embodiments are specific examples which by no means should be considered to be limiting. Rather, this example is only intended to explain that the finding of a precise algorithm correlating a kinematic variable in the frequency space with a coordinate of the hitting point actually works. However, this algorithm can generally be modified in various ways and empirically adapted to the geometries and vibration behaviors of many different articles. However, on the basis of the above explained example, the knowledge of the specific vibration behavior of a specific article will enable the person skilled in the art to determine a characteristic frequency interval corresponding to this vibration behavior as well as an appropriate characteristic value. The determination of equations corresponding to the equations indicated above for the case of the tennis racket is then possible to the person skilled in the art by simple experiments.

1. A method for determining at least one first coordinate of the hitting point of an object on the surface of an article, wherein the longitudinal axis of the article defines an x-coordinate, the transverse axis of the article along its width defines a y-coordinate and the perpendicular to the x-coordinate and the y-coordinate defines a z-coordinate, comprising the following steps:
(a) measuring at least one first kinematic variable in a first direction at a first point of the article as a function of time;
(b) transforming the measured first kinematic variable into the frequency space; and
(c) determining the first coordinate of the hitting point on the basis of the transformed kinematic variable in the frequency space.

2. A method for determining a first and a second coordinate of the hitting point of an object on the surface of an article, wherein the longitudinal axis of the article defines an x-coordinate, the transverse axis of the article along its width defines a y-coordinate and the perpendicular to the x-coordinate and the y-coordinate defines a z-coordinate, comprising the following steps:
(a) measuring a first kinematic variable in a first direction at a first point of the article as a function of time;
(b) measuring a second kinematic variable in a second direction at a second point of the article as a function of time;
(c) transforming the measured first kinematic variable and the measured second kinematic variable and/or a linear combination of the measured first and second kinematic variables into the frequency space; and
(d) determining the first and second coordinates of the hitting point on the basis of the transformed kinematic variable(s) in the frequency space.

3. The method according to claim 2, wherein the first direction is substantially identical to the second direction.

4. The method according to claim 2, wherein the first point differs from the second point.

5. The method according to claim 1, wherein the determination of the first and/or the second coordinate of the hitting point on the basis of the transformed kinematic variable(s) in the frequency space comprises:
(a) determining a characteristic frequency interval;
(b) determining at least one characteristic value of the first and/or the second kinematic variable with respect to the characteristic frequency interval; and
(c) determining the first and/or the second coordinate of the hitting point on the basis of the at least one characteristic value.

6. The method according to claim 5, wherein the lower limit of the characteristic frequency interval is between 0 Hz and 100 Hz.

7. The method according to claim 5, wherein the upper limit of the characteristic frequency interval is between 20 Hz and 500 Hz.

8. The method according to claim 5, wherein the characteristic value comprises one or a combination of the following values: local or absolute minimum of the first and/or the second kinematic variable in the characteristic frequency interval, local or absolute maximum of the first and/or the second kinematic variable in the characteristic frequency interval, mean value of the first and/or the second kinematic variable in the characteristic frequency interval, mean value of the first and/or the second kinematic variable in a partial interval of the characteristic frequency interval.

9. The method according to claim 5, wherein the first and/or the second coordinate is a function of the characteristic value.

10. The method according to claim 1, wherein the first and/or the second kinematic variable is the acceleration.

11. The method according to claim 2, wherein the determination of the first and/or the second coordinate of the hitting point on the basis of the transformed kinematic variable(s) in the frequency space comprises:
(a) determining a characteristic frequency interval;
(b) determining at least one characteristic value of the first and/or the second kinematic variable with respect to the characteristic frequency interval; and
(c) determining the first and/or the second coordinate of the hitting point on the basis of the at least one characteristic value.

13. The method according to claim 11, wherein the lower limit of the characteristic frequency interval is between 0 Hz and 100 Hz.

13. The method according to claim 11, wherein the upper limit of the characteristic frequency interval is between 20 Hz and 500 Hz.

14. The method according to claim 11, wherein the characteristic value comprises one or a combination of the following values: local or absolute minimum of the first and/or the second kinematic variable in the characteristic frequency interval, local or absolute maximum of the first and/or the second kinematic variable in the characteristic frequency interval, mean value of the first and/or the second kinematic variable in the characteristic frequency interval, mean value of the first and/or the second kinematic variable in a partial interval of the characteristic frequency interval.

15. The method according to claim 11, wherein the first and/or the second coordinate is a function of the characteristic value.

16. The method according to claim 11, wherein the lower limit of the characteristic frequency interval is between 5 Hz and 80 Hz.

17. The method according to claim 11, wherein the lower limit of the characteristic frequency interval is between 10 Hz and 50 Hz.

18. The method according to claim 11, wherein the upper limit of the characteristic frequency interval is between 25 Hz and 400 Hz.

19. The method according to claim 11, wherein the upper limit of the characteristic frequency interval is between 30 Hz and 300 Hz.

20. The method according to claim 5, wherein the lower limit of the characteristic frequency interval is between 5 Hz and 80 Hz.
